(19) United States
(12) Patent Application Publication
(10) Pub. No.: US 2003/0061000 A1
(43) Pub. Date: Mar. 27, 2003

(54) Method and system for performing a track search in an optical storage system

(76) Inventors: Kechen Cheng, Palo Alto, CA (US); David Deqian Chen, San Jose, CA (US)

Correspondence Address: Joseph A. Sawyer Jr., SAWYER LAW GROUP LLP, P.O. Box 51418, Palo Alto, CA, 94303, US

(21) Appl. No.: 09/965,956

(22) Filed: Sep. 27, 2001

(51) Int. Cl. G06F 15/00

(52) U.S. Cl. 702/150

(57) ABSTRACT

A method and system for searching in a track in an optical storage system is disclosed. The optical storage system includes an optical pick up unit (OPU) coupled to a carriage. The method and system comprises receiving a command to indicate that the OPU is to move to a target position of the track. The method and system includes providing first and second output signals, each of the output signals having a rising edge and a falling edge. The rising and falling edges indicate movement of the carriage. The method and system further includes counting each of the rising edges and the falling edges of each of the first and second output signals and providing a sensor count for each of the rising and falling edges; a plurality of sensor counts are provided by movement of the carriage. The method and system finally includes utilizing the plurality of sensor counts to determine the distance the carriage has moved and moving the OPU to the target position based upon the plurality of sensor counts. The spindle speed at each sledge count location can be pre-calculated and stored in the look-up table, and the CLV spindle speed at target radius can be adjusted on the fly and hence reduce the seek time. By using the sledge sensor counts, the surface of the optical disk can be divided into several zones. The spindle speed can be defined and read from a look-up table for zone CAV control scheme. By dividing the disk surfaces into several zones, whenever any seek error happens during the seek operation the system processor can issue the command to re-seek to the target location rapidly without doing the recal procedure.

### FIELD OF THE INVENTION

The present invention relates to optical storage systems, and more particularly to a method and system for performing a track search in an optical storage system.

### BACKGROUND OF THE INVENTION

The demand for mass data storage continues to increase with expanding use of data processing systems and personal computers. Optical data storage systems are becoming an increasingly popular means for meeting this expanding demand. These optical data systems provide large volumes of relatively low-cost storage that may be quickly accessed.

In optical storage systems, coded video signals, audio signals, or other information signals are recorded on a disc in the form of information tracks on one or both planar surfaces of the disc. At the heart of an optical storage system is at least one laser (or other light source). In a first operating mode, the laser generates a high-intensity laser beam that is focused on a small spot on an information track of a rotating storage disc.

Subsequently, when the operator desired to reproduce or read the previously recorded information, the laser enters a second operating mode. In this mode, the laser generates a low-intensity laser beam that is again focused on the tracks of the rotating disc. This lower intensity laser beam does not heat the disc above its Curie Point. The laser beam is, however, reflected from the disc surface in a manner indicative of the previously recorded information due to the presence of the previously formed pits, and the previously recorded information may thereby be reproduced. Since the laser may be tightly focused, an information processing system of this type has advantages of high recording density and accurate reproduction of the recorded information.

The components of a typical optical system include a housing with an insertion port through which the user inserts the recording media into the drive. This housing accommodates, among other items, the mechanical and electrical subsystems for loading, reading from, writing to, and unloading an optical disc. The operation of these mechanical and electrical subsystems is typically within the exclusive control of the data processing system to which the drive is connected.

In order to attain a precise reading of the information stored on the disc, it is necessary to be able to move the objective lens in both a focusing (i.e., perpendicular to the plane of the disc) or Z direction in order to focus the laser beam to a small point of light on a precise location of the disc to write or retrieve information, and in a tracking (i.e., radial from the center of the disc) or Y direction to position the beam over the exact center of the desired information track on the disc. Focus and tracking corrections may be effected by moving the objective lens in either the direction of the optical axis of the lens for focusing, or in a direction perpendicular to the optical axis for tracking.

Optical recording and playback systems, such as those utilizing optical memory disks, compact disks, or video disks, require precise focusing of an illuminating optical beam through an objective lens onto the surface of an optical disc. The incident illuminating beam is generally reflected back through the objective lens, and is then used to read information stored on the disc. Subsequent to passing back through the objective lens, a portion of the reflected beam is typically directed to an apparatus designed to gauge the focus of the illuminating beam on the disc. Information extracted from the reflected beam by this apparatus may then be used to adjust the focus of the illuminating beam by altering the position of a movable objective lens relative to the disc.

Optical data storage systems that utilize a focused laser beam to record and instantaneously playback information are very attractive in the computer mass storage industry. Such optical data storage systems offer very high data rates with very high storage density and rapid random access to the data stored on the information medium, most commonly an optical disc. In these types of optical disc memory systems, reading and writing data is often accomplished using a single laser source functioning at two respective intensities. During either operation, light from the laser source passes through an objective lens that converges the light beam to a specific focal point on the optical disc. During data retrieval, the laser light is focused on the recording medium and is altered by the information of the data storage medium. This light is then reflected off the disc, back through the objective lens, to a photodetector. It is this reflected signal that transmits the recorded information. It is thus especially important that, when information is being written to or read from the memory, the objective lens, and the exiting focused beam, be precisely focused at the center of the correct track so that the information may be accurately written and retrieved.

For an example of a conventional system, please refer to FIG. 1. FIG. 1 is a diagram illustrating a conventional optical storage system 100. The system 100 comprises a compact disk (“CD”) 102, a spindle motor 104, a spindle motor drive 106, an optical pick up unit (OPU”) 108, a sledge sensor encoder and related electronics (“sledge sensor”) 110, a DC lead screw sledge motor 112, a coarse carriage 114, a focus servo system 116, first and second receivers 118, 120, a sledge motor driver 122, and a tracking servo system 124.

The OPU 108 comprises an objective lens 113, a tracking actuator 109 and a focus actuator 111. The OPU 118 is sitting on the coarse carriage 114 and a DC lead screw type sledge motor 112 drives the coarse carriage 114. A CD 102 is played from the underside with a light beam 107. The beginning of the CD 102 is near the center and the light beam 107 moves outward toward the edge as the program plays. The light beam 107 is focused up onto the bottom of the CD 102 through the objective lens 113 located below the CD 102. The tracking and focus actuators 109, 111, with their mobile parts totally suspended on elastic elements, are dedicated to keep the laser spot in focus and on track. The focus actuator 111 will perform the focus adjustment in the normal (or y) direction and the tracking actuator 109 will perform the on track adjustment in the radial (or x) direction relative to the disk being positioned by the sledge motor 112 at a raw radial location.

As the CD 102 is played from beginning to end, the objective lens 113 on the OPU 108 is driven by sledge motor 112 across the disk. A lead screw sledge system comprises a motor 112 turning a lead screw 115 that moves an attached load thereby converting the rotary motion into linear movement. The sledge sensor 110 is coupled to the motor and utilized to sense the rough location of the light beam 107 along the disk surface. The sledge sensor 110 has a laser diode on one side of an encoder disk 117 to transmit the light, and light receivers 118, 120 on another side to sense the light through the holes of the encoder disk 117. By sensing the lights through the holes, the sledge encoder electronics will generate “high-low” digital output signals 119, 121 to represent the light or no light.

Conventional optical disk drive systems use open loop control of the motor speed in track search operations. In an open loop control, the spindle motor is driven in a kick and brake manner for changing the rotational speed, and the rotational speed of the motor is a function of the radius of the optical disk when the optical drive is operated in a constant linear velocity (“CLV”) mode across a variety of radiuses. When a track closer to the circumference of the disk is to be assessed, such as when the optical pickup must move from track A to track B, the motor must reduce the rotational speed of the disk until the electronics is able to synchronize with the sub-code bits stored on the desired track (typically when the speed reaches±50% of the proper speed, due to the large tolerances built into the data recovery electronics), at which time closed loop speed control is used based on the sub-code sync signal. This open loop control system is problematic because both time and power are wasted when the motor speed adjustments must be made with unavoidable overshoots and undershoots.

Accordingly, there exists a need for a method and system for conducting tracking and seek operations in an optical storage system in a more efficient manner. The improved method and system should be cost effective and capable of being easily adapted to existing technology. The present invention addresses such a need.

### SUMMARY OF THE INVENTION

A method and system for searching in a track in an optical storage system is disclosed. The optical storage system includes an optical pick up unit (OPU) coupled to a carriage. The method and system comprises receiving a command to indicate that the OPU is to move to a target position of the track. The method and system includes providing first and second output signals, each of the output signals having a rising edge and a falling edge. The rising and falling edges indicate movement of the carriage. The method and system further includes counting each of the rising edges and the falling edges of each of the first and second output signals and providing a sensor count for each of the rising and falling edges; a plurality of sensor counts are provided by movement of the carriage. The method and system finally includes utilizing the plurality of sensor counts to determine the distance the carriage has moved and moving the OPU to the target position based upon the plurality of sensor counts. The spindle speed at each sledge count location can be pre-calculated and stored in the look-up table, and the CLV spindle speed at target radius can be adjusted on the fly and hence reduce the seek time.

By using the sledge sensor counts, the surface of the optical disk can be divided into several zones. The spindle speed can be defined and read from a look-up table for zone CAV control scheme.

By dividing the disk surfaces into several zones, whenever any seek error happens during the seek operation the system processor can issue the command to re-seek to the target location rapidly without doing the recal procedure.

### BRIEF DESCRIPTION OF THE FIGURES

FIG. 1 is a diagram illustrating a conventional optical storage system.

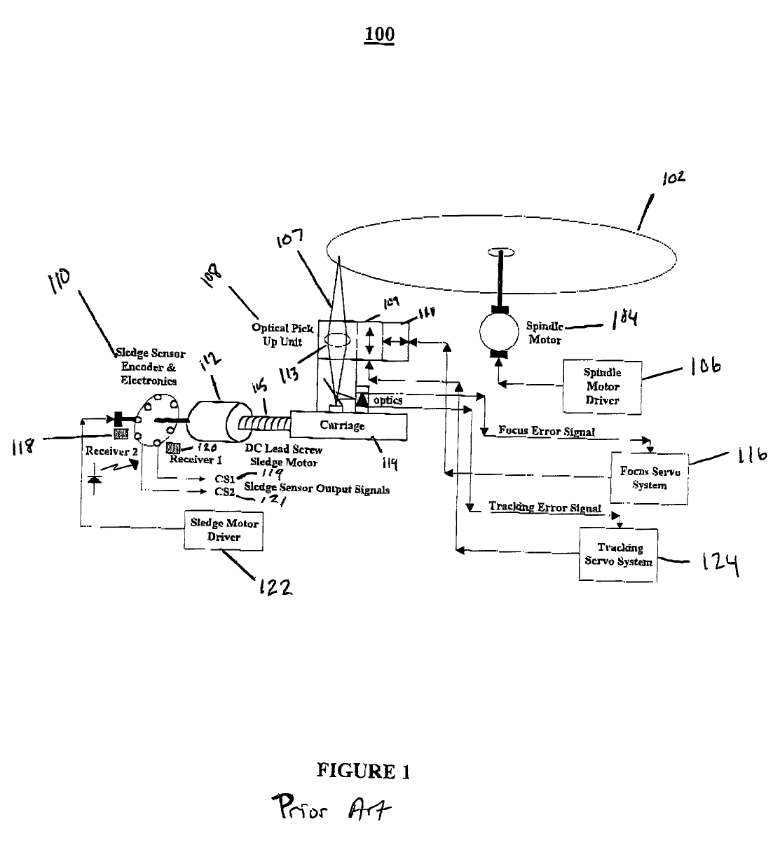

FIG. 2 is a diagram illustrating a preferred embodiment of a system in accordance with the present invention.

FIG. 3 is an example of the sledge sensor counting scheme.

FIG. 4 is an example of sledge sensor count table.

FIG. 5 is a flow chart of the closed coarse position scheme in accordance with the present invention.

FIG. 6 is a flow chart of a method of performing error recovery in accordance with the present invention.

### DETAILED DESCRIPTION

The present invention provides a method and system for utilizing a sledge sensor in an optical storage system. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

A method and system for performing a track search in an optical storage system are disclosed. Through the use of the method and system in accordance with the present invention, the amount of time required to perform track search operations in an optical storage system is significantly reduced.

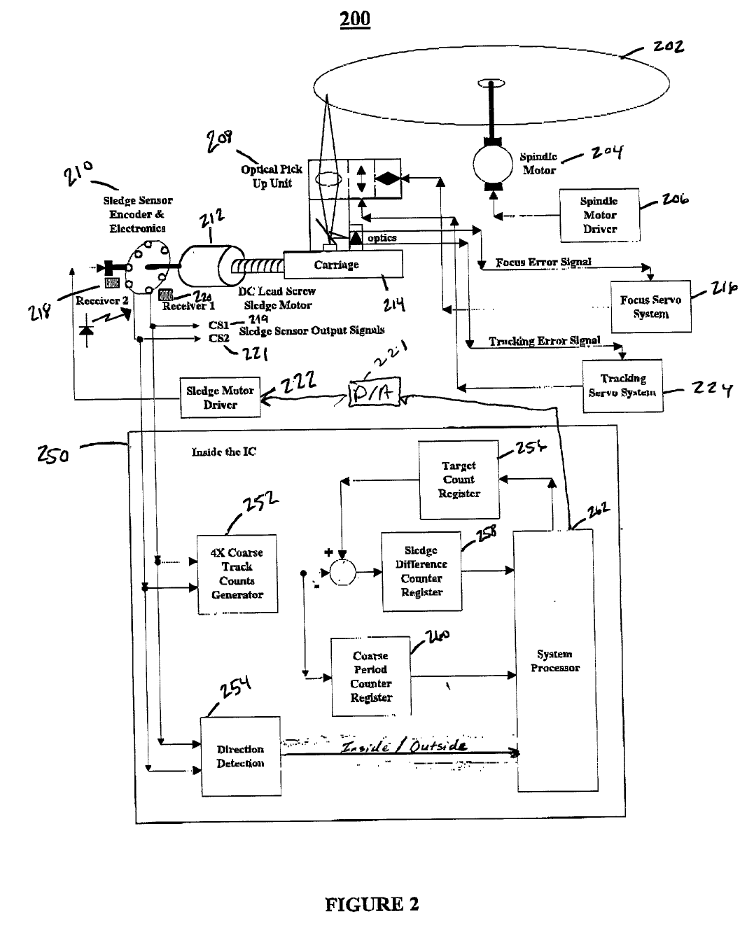

To more particularly describe the features of the present invention, please refer to FIG. 2. FIG. 2 is a diagram illustrating a preferred embodiment of a system 200 in accordance with the present invention. The system 200 in accordance with the present invention includes many elements described in the conventional system. For example, the system 200 comprises an optical storage disk 202, a spindle motor 204, a spindle motor driver 206, an optical pick up unit (“OPU”) 208, a sledge sensor encoder and related electronics (“sledge sensor”) 210, a DC lead screw sledge motor 212, a coarse carriage 214, a focus servo system 216, first and second receivers 218, 220, a sledge motor driver 222, and a tracking servo system 224.

The system 200 also includes an integrated (IC) 250 for more efficiently performing track search operations. The circuit 250 includes a track counter generator 252 that receives first and second sledge sensor output signals 219 and 221. The sledge sensor output signals 219 and 221 are also provided to the direction detector 254. The direction detector 254 provides a signal to system processor 262. The output of the track counts generator is provided to a summer 251 and to a coarse period counter register 260. The system processor 262 provides a signal to the target count register 256. The target count register 256 provides a signal to the summer 251. The output of the summer 251 is provided to sledge difference counter register 258. The coarse period counter register 260 and the sledge difference counter register 258 both provide outputs to the system processor 262.

The output from the track counts generator 252 is provided to a summer 251 and to a coarse period counter register. The coarse period counter register 260 provides as an output the velocity of the OPU 200. A sensor count to target position is provided from the system processor to the target count register 256. The difference between value in the target count register and value provided by the track count generator is summed in summer 251 and provided to the sledge difference counter register 258. The difference value is from the counter register 258 to the system processor. This value is utilized by the system processor along speed value from register 260 to control the movement of the carriage via the D/A converter 221.

The target count register 256 calculates and stores the number of sensor counts required for the OPU 208 to move from its current position to a desired target position. The sledge difference counter register 258 stores the number of sensor counts remaining to reach the desired target position. The coarse period counter register 260 calculates and stores the period for each sensor count, i.e., the amount of time it takes to move from count 1 to count 2.

Sensor Counts

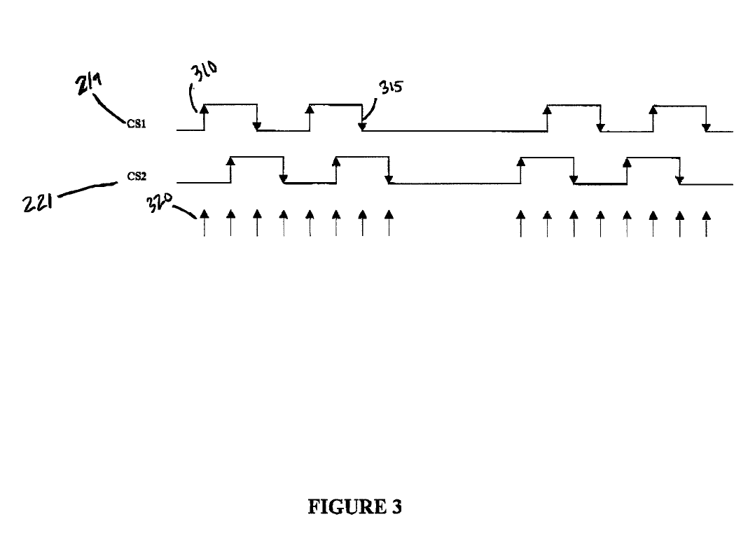

FIG. 3 is a chart that illustrates the output of sledge sensor output signals and the resulting sensor counts provided by the circuit 250. Referring to FIGS. 2 and 3 together, the track count generator 252 receives two sledge sensor output signals 219 and 221 to provide a sensor counting scheme. The output signals 219 and 221 as is seen are quadrature signals. The track count generator 252 counts the rising edges 310 as one sensor count and the falling edges 315 as a second sensor count 320 of each of the sledge sensor output signals 219 and 221 wherein movement of each rising and falling edge indicates movement of the carriage. Accordingly, the granularity of the sensor counts to indicate movement is greater than with a conventional sensor (i.e., four sensor counts for the two signals) thereby increasing the accuracy when determining movement of the carriage 214.

In order to establish a reference position for the sensor counts 320, the OPU 208 is first positioned to touch the spindle motor 204. The reference position is utilized as a mechanical stopper position. Accordingly, the mechanical stopper position is used as a reference position for a sensor “0” count position. The position of the carriage 214 upon which the OPU 208 is sitting can be determined relative to the reference position by “counting” the sensor counts.

Detecting of the Direction of Movement of the Carriage

The sledge sensor output signals 219 and 221 are utilized for detecting the direction of the carriage 214. In a preferred embodiment, a direction detector 254 detects a phase difference between the two output signals 219 and 221 and utilizes this phase difference to determine the direction of the movement of the carriage 214. For example, the rising and falling edges of the second signal 221 can be utilized as a reference point to sample the first signal 219, e.g., a rising edge of the second signal 221 in relation to the first signal 219 could indicate movement from in a first direction (i.e., form inside to outside) whereas a falling edge of the second signal 221 in relation to the first signal 219 could indicate movement (i.e., outside to inside). Accordingly, the direction detector 254 provides a signal to the system processor 262 indicating that the carriage 214 is moving in a particular direction. This information is then stored in the system processor 262 to be utilized as a coarse position control reference.

Virtual Disk Zones

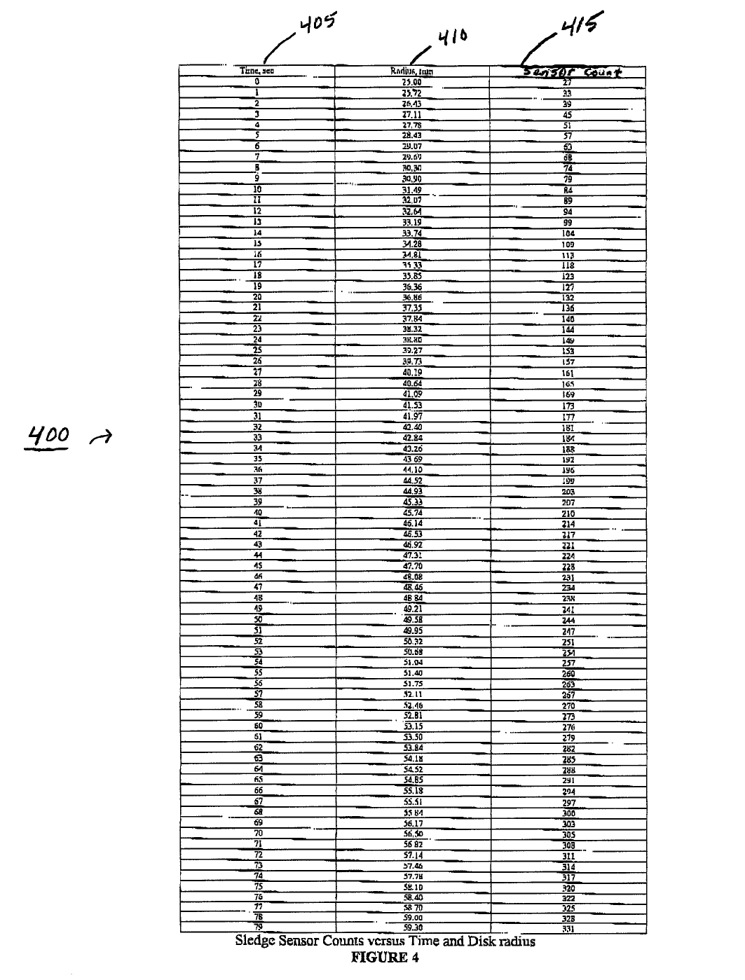

In a preferred embodiment, a conventional optical storage disk would have a total sensor count value of 350. Based on this information, a sensor count table (relative sledge sensor counts vs. the time) can be generated. FIG. 4 is an example of a sensor count table 400 utilizing a conventional storage disk. The sensor count table 400 includes a time column 405, a radius column 410, and a sensor count column 415. The table illustrates a sensor count value in the sensor count column 415, the associated disk radius in the radius column 410 and the embedded time information at each associated disk radius in the time column 405.

Referring to table 400, each of the sensor count values in the sensor count column represents a “virtual disk zone” wherein a virtual disk zone represents a specific radius on the disk. That is, that each sensor count value in a particular column is representative of a different disk radius. Utilizing this concept, a conventional 60 mm disk can be divided into a maximum of 350 “virtual” disk zones. For example, referring to FIG. 4, the sensor count value 27 in the sensor count column 415 corresponds to a disk radius of 25 mm.

Accordingly, based on the different disk zones or sensor count values, a spindle Constant Linear Velocity (CLV) speed in that zone is pre-calculated and a speed profile table can be generated. The speed profile table can accordingly be utilized for track searches, CLV spindle control and error recovery.

Track Search System

To further understand the system for searching for a track in accordance with the present invention, please refer back to FIG. 2. The spindle motor drive 206 determines the desired motor speed for the target zone through the speed profile table. The speed can therefore be quickly and accurately changed to a desired speed, typically by the time the light beam reaches a target zone during a track search operation.

The system microprocessor 262 sends a coarse moving command to the target count register 254. The number of sensor counts needed to move the carriage 214 from the current position to the target zone is calculated and set into the target count register 254. In order to move the light beam to its target position, the sledge motor 212 is energized to move the OPU 208 to its target position. Before the light beam is moved, “the number of tracks to go” is calculated and the related spindle motor driver 206 speed of the target location is determined via the speed profile table. The “number of tracks to go” to the target zone is then converted to the “number of sensor counts to go”.

As the light beam is moved to its target zone, the target count is reduced by one after each count is detected by the track count generator 252. This number is then stored in the sledge difference counter register 258 while the coarse period counter register 260 calculates and stores the period for each count. For example, if the target count is 10, the number 9 will be stored in the sledge difference counter register 258 after the first count is detected by the track count generator 252. Once the sledge difference counter register 258 reaches 0, the target zone is reached.

The spindle speed is adjusted on the fly to the next target zone and once the target zone is reached, the spindle speed is maintained until the operation is complete. By adjusting the spindle speed on the fly, the servo seek time is improved by eliminating the spindle sync up time typically required for spindle control after the light beam reaches the target location.

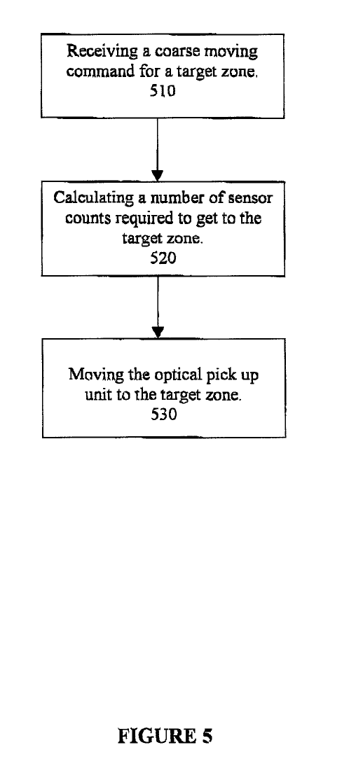

FIG. 5 is a flow chart of the system for searching for a track in accordance with the present invention. As before mentioned, a coarse moving command for a target zone is received by the target count register, via step 510. Next, the number of sensor counts required to get to the target zone is calculated by the system processor 120, via step 520. This involves converting the distance to the target zone into a number of sensor counts to provide a target count. The OPU 208 is then moved to the target zone, via step 530. In a preferred embodiment, as the OPU 208 is moved, target count is reduced by one after each count is detected by the track count generator. This number is subsequently stored in the sledge difference counter register 258. The spindle speed is adjusted on the fly by the spindle motor driver and the target zone is reached once the sledge difference counter register reaches 0. Again, by adjusting the spindle speed, preferably on the fly, servo seek time is improved by eliminating the spindle sync up time typically required for spindle CLV control after the light beam reaches the target location.

Although the above-described embodiment is described in the context of being implemented in a CLV mode of operation, one of ordinary skill in the art will readily recognize the existence of a constant angular velocity (CAV) mode of operation. Utilized in conjunction with the virtual zone concept, a zone CAV mode of operation is contemplated. Accordingly, the speed profile table can be designed to accommodate a combination of a zone CAV mode and CLV mode of operation such that the system can run at the maximum data transfer rate permitted by the data processing electronics, or to minimize power consumption.

Error Recovery

Due to the imperfect nature of mechanical systems, a disk defect, a seeking error or any environmental shock and vibration can push the light beam off its target location. The error recovery routine will be activated once any error condition happens. To be able to recover from an error condition and move the light beam back to its original position rapidly is a challenging task.

In order to recover from an error condition, most conventional methodologies conduct a system recalibration (or “recal” to always move the light beam back to predefined position and then wait for the system microprocessor to re-send the command to move light beam back to its original position.

In a method and system in accordance with the present invention, the current zone location of the light beam is constantly updated and stored in the microprocessor 262. Accordingly, once an error condition happens and the light beam is moved from its current zone, the target zone and the predefined spindle motor 204 speed (from the speed profile table) are retrieved from the microprocessor 262. The light beam is then moved back to its original zone (the zone prior to the error condition) and the spindle motor is set. This process is faster than the conventional method since there is no need to wait for the system microprocessor 262 to re-send the previous move command.

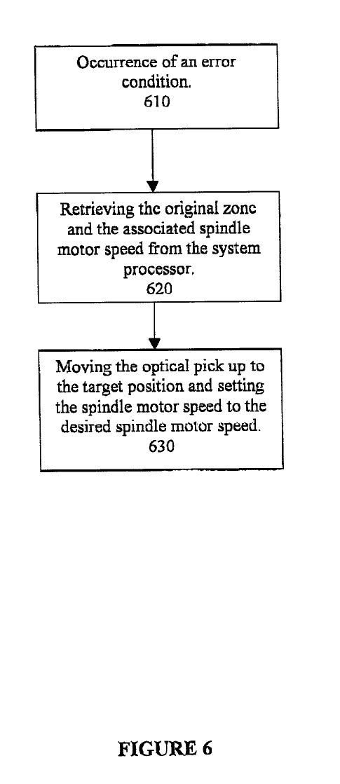

FIG. 6 is a flowchart of a method of performing error recovery in accordance with the present invention. First, an error condition is detected, via step 610. An error condition comprises an event that moves the light beam from its current zone position. Next, the original zone and the associated spindle motor 204 speed are retrieved from the system processor, via step 620. Preferably, the original zone comprises the zone that the light beam occupied prior to the error condition and the associated spindle motor 204 speed is predefined and retrieved from a speed profile table. Finally, the light beam is moved back to the original zone and the spindle motor 204 is set, via step 630. Again, this process is faster than the conventional method since there is no need to wait for the system microprocessor to re-send the previous move command.

A method and system for performing a track search in an optical storage system are disclosed. Through the use of the method and system in accordance with the present invention, the amount of time required to perform track search operations in an optical storage system is significantly reduced.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of appended claims.

What is claimed is:

1. A method for determining movement of a carriage in an optical storage system; the method comprising the steps of:
(a) providing first and second output signals, each of the output signals having a rising edge and a falling edge, wherein the rising and falling edges indicate movement of the carriage;
(b) counting each of the rising edges and the falling edges of each of the first and second output signals;
(c) providing a sensor count for each of the rising and falling edges; wherein a plurality of sensor counts are provided by movement of the carriage; and
(d) utilizing the plurality of sensor counts to determine the distance the carriage has moved.

2. The method of claim 1 wherein the sensor counts are utilized to provide direction detection of the carriage.

3. The method of claim 2 wherein a phase difference is detected between the first and second output signal to determine the direction of the movement of the carriage.

4. The method of claim 3 wherein the rising and falling edges of one of the two output signals is utilized as a reference point to sample the other of the two output signals.

5. The method of claim 4 wherein the sensor counts are utilized to provide the distance that the carriage has moved.

6. The method of claim 1, wherein the utilizing step (d) comprises:
(d1) providing a reference position for the carriage; and
(d2) determining the position of the carriage in relation to the reference position by counting the sensor counts.

7. A method for searching for a track in an optical storage system, the optical storage system including an optical pick up unit (OPU) coupled to a carriage; the method comprising the steps of:
(a) receiving a command to indicate that the OPU is to move to a target position of the track;
(b) providing first and second output signals, each of the output signals having a rising edge and a falling edge, wherein the rising and falling edges indicate movement of the carriage;
(c) counting each of the rising edges and the falling edges of each of the first and second output signals;
(d) providing a sensor count for each of the rising and falling edges; wherein a plurality of sensor counts are provided by movement of the carriage;
(e) utilizing the plurality of sensor counts to determine the distance the carriage has moved; and
(f) moving the OPU to the target position based upon the plurality of sensor counts.

8. The method of claim 7 wherein the sensor counts are utilized to provide the distance that the carriage has moved.

9. The method of claim 7, wherein the utilizing step (e) comprises:
(e1) providing a reference position for the carriage; and
(e2) determining the position of the carriage in relation to the reference position by counting the sensor counts.

10. A system for determining movement of a carriage in an optical storage system; the system comprising:
first and second output signals, each of the output signals having a rising edge and a falling edge, wherein the rising and falling edges indicate movement of the carriage;
a register for counting each of the rising edges and the falling edges of each of the first and second output signals, and for providing a sensor count for each of the rising and falling edges; wherein a plurality of sensor counts are provided by movement of the carriage; and
a processor for utilizing the plurality of sensor counts to determine the distance the carriage has moved.

11. The system of claim 10 wherein the sensor counts are utilized to provide direction detection of the carriage.

12. The system of claim 11 wherein a phase difference is detected between the first and second output signals to determine the direction of the movement of the carriage.

13. The system of claim 12 wherein the rising and falling edges of one of the two output signals is utilized as a reference point to sample the other of the two output signals.

14. The system of claim 13 wherein the sensor counts are utilized to provide the distance that the carriage has moved.

15. The system of claim 10, wherein the processor comprises:
means for providing a reference position for the carriage; and
means for determining the position of the carriage in relation to the reference position by counting the sensor counts.

16. A circuit for determining movement of a carriage in an optical storage system comprising:
a counts generator for receiving first and second output signals and providing a plurality of sensor counts;
a detector for receiving the first and second output signals and providing an indication of the direction of movement of the carriage; and
a processor coupled to the generator and the detector for receiving the sensor counts and indicator of direction and controlling the movement based upon the sensor counts and the direction indicator.

17. A system for searching for a track in an optical storage system, the optical storage system including an optical pick up unit (OPU) coupled to a carriage; the system comprising:
a command to indicate that the OPU is to move to a target position of the track;
first and second output signals, each of the output signals having a rising edge and a falling edge, wherein the rising and falling edges indicate movement of the carriage;
a register counting each of the rising edges and the falling edges of each of the first and second output signals; and for
providing a sensor count for each of the rising and falling edges; wherein a plurality of sensor counts are provided by movement of the carriage;
a processor for utilizing the plurality of sensor counts to determine the distance the carriage has moved; and
a driver for moving the OPU to the target position based upon the plurality of sensor counts from the processor.

18. The method of claim 17 wherein the sensor counts are utilized to provide the distance that the carriage has moved.

19. The method of claim 17, wherein the utilizing step (d) comprises:
(d1) providing a reference position for the carriage; and
(d2) determining the position of the carriage in relation to the reference position by counting the sensor counts.
